(19) United States
(12) Patent Application Publication
(10) Pub. No.: US 2026/0264850 A1
(43) Pub. Date: Sep. 10, 2026

(54) AIRCRAFT AND METHOD OF FLYING SAID AIRCRAFT

(71) Applicant: Blainjett Aviation LLC, Frankford, DE (US)

(72) Inventors: Kyriacos Mark Zachary, Frankford, DE (US); Phillip Peter Johnston, Winlock, WA (US); Eric Tegler, Davidsonville, MD (US)

(21) Appl. No.: 18/721,901

(22) PCT Filed: Dec. 20, 2022
(86) PCT No.: PCT/US2022/053544

§ 371 Date: Jun. 20, 2024

Related U.S. Application Data
(60) Provisional application No. 63/361,424, filed on Dec. 20, 2021.

(51) Int. Cl. B64C 29/00; B64C 9/36; B64C 25/66; B64C 39/02

(52) U.S. Cl. CPC B64C 29/0025; B64C 9/36; B64C 39/026; B64C 25/66

(57) ABSTRACT

An aircraft has port side and starboard side propeller blades that each have a portion of the blade hidden or overlapping with the fuselage. This hidden or overlapping blade may extend into a slot of the fuselage. The advancing or retreating blades may overlap the fuselage for better performance. The fuselage has vents that open to allow airflow through the fuselage from the top to the bottom of the fuselage to enable lift from the propeller rotating in the overlapping portion of the fuselage. The vents may direct airflow through the fuselage for creating forward and/or reverse thrust and for maneuvering the aircraft. An aircraft may be a drone or may be a pilot operated aircraft, such as a hoverbike having a seat to carry a pilot during flight.

### CROSS REFERENCE TO RELATED APPLICATIONS

This application claims the benefit of priority to U.S. provisional patent application No. 63/361,424, filed on Dec. 20, 2021; the entirety of which is hereby incorporated by reference herein.

### BACKGROUND OF THE INVENTION

### Field of the Invention

The invention relates to an aircraft having port and starboard propellers that at least partially overlap with the fuselage such that a portion of the propeller extends from the fuselage and a stern propeller having a rotational axis that is aligned with the length axis of the aircraft.

### BACKGROUND

Propeller type aircraft often use two or more propellers that can be operated to enable hovering, forward flight, rotation of the aircraft or yaw, as well as roll and pitch. In most cases the propeller blade is exposed on both the advancing, moving into the direction of forward flight, and retreating sides, moving back with the airflow over the aircraft during forward flight. The speed of a propeller driven aircraft having propeller blades spinning about a rotational axis that is perpendicular to the direction of travel is limited by this retreating blade. A multirotor aircraft, such as a quadcopter can balance itself even with the losses in efficiency over the retreating blades because it has more than one propeller. A helicopter uses cyclic pitch to compensate for the loss of lift on the retreating blade side but can only do so at a certain limit. Velocity-Never-Exceed (VNE) is a calculation every helicopter pilot has to consider when flying. Certain factors like barometric pressure and altitude dictate the speed a helicopter can fly before losing lift on the retreating rotor blades, that can eventually cause a loss of control.

### SUMMARY OF THE INVENTION

The invention is directed to an aircraft that has port side and starboard side propeller blades that each have a portion of the blade hidden or overlapping with the fuselage. This hidden or overlapping blade may extend into a slot of the fuselage. The advancing or retreating blades may overlap the fuselage for better performance. When the hidden blades are retreating, they avoid the relative-wind airflow that causes loss of lift at high speeds. The outer, exposed propeller blades can slow down, stop and act as wings at high speeds. A low speed aircraft with hidden blades that are advancing, can bypass the additional drag that advancing blades generate. The exposed retreating blades in this scenario have a low drag interface with the relative wind due to the rearward sweeping. That retreating motion can also vector thrust toward the stern generating some useful forward thrust. The fuselage may have vents that open to allow airflow through the fuselage from the top to the bottom of the fuselage to enable lift from the propeller rotating in the overlapping portion of the fuselage. The vents may direct airflow through the fuselage for creating forward and/or reverse thrust and for maneuvering the aircraft. An aircraft may be a drone or may be a pilot operated aircraft, such as a hoverbike having a seat to carry a pilot during flight.

An aircraft includes a fuselage having a length from a front to a back or stern, and a width from a port side to a starboard side. A port propeller having port propeller blades is coupled to the fuselage and configured on said port side of the fuselage. A portion of the port propeller blades overlap the fuselage. A portion of the port propeller blade, such as about one blade length, may extend out from the port side of the fuselage. A starboard propeller having starboard propeller blades is coupled to the fuselage and configured on the starboard side of the fuselage. A portion of the starboard propeller blades overlap the fuselage. A portion of the starboard propeller blade, such as about one blade length, may extend out from the starboard side of the fuselage. An aircraft may have two or more, three or more or even four or more port and/or starboard propellers, and any range between and including the number of propellers provided. A larger number of propellers may be required for the hoverbike aircraft as more lift may be required for carrying the pilot.

Each of the port propellers may rotate about a rotational axis and the rotational axis of each may be substantially parallel, or within about 20 degrees of parallel. Likewise, each of the starboard propellers may rotate about a rotational axis and the rotational axis of each may be substantially parallel, or within about 20 degrees of parallel. Also, each of the port and/or starboard propellers may rotate in the same direction or the port propellers may rotate in an opposite direction to the starboard propellers. Also, in a specific arrangement, the forward port propeller and the aft or stern starboard propeller may rotate in the same direction while the stem port propeller and forward starboard propeller rotate in the same direction, but opposite the forward port propeller and the stern starboard propeller. This arrangement may provide control of yaw.

The propellers may be operated at the same rotational speed or may be controlled to operate at different speeds for roll, pitch or yaw of the aircraft. The stern propellers may be operated at a higher speed than the more forward propellers to produce a downward pitch of the aircraft for example. Also, the propeller blades may be slowed and then stopped to position a propeller blade as a wing to provide additional lift during flight.

An aircraft may comprise a stern propeller that is coupled with the stern of the aircraft to provide thrust to the aircraft. The stern propeller may have a rotational axis that is substantially parallel with the length axis of the aircraft, within about 20 degrees of parallel.

The propeller blades may be configured to overlap with each other and may be offset vertically such that timing and control to prevent collision of overlapping blades is not required.

The propeller blades may also be configured with pitch control to maximize thrust created by the propeller blade, such as described in U.S. Pat. No. 10,272,998, to Zachary, incorporated by reference herein.

The propellers may be configured with the advancing or retreating portion of the propeller blade overlapping with the fuselage. It may be desirable to have the retreating blade overlap with the fuselage to enable higher speed forward flight. Loss of lift on the retreating side of a propeller begins immediately as an aircraft starts moving forward. Negative lift will be produced when the forward speed of the aircraft exceeds the rotational speed of a retreating propeller blade.

A fuselage may have fuselage openings to allow airflow through the fuselage, such as from the front to the back and particularly from the top to the bottom to enable lift and flight of the aircraft. The fuselage may be configured over the propeller blades and/or under the propeller blades. In an exemplary embodiment, the fuselage forms a slot for receiving a portion of the propeller blades therein, an overlapped portion of the propeller blades. These slots may extend into the fuselage along the port and starboard sides of the fuselage when the port propeller and starboard propellers extend out from the port and starboard sides, respectively. The fuselage may also have a fuselage opening between the port and starboard sides, such as being centrally located along a centerline of the aircraft. This central fuselage opening may form a slot between the top portion of the fuselage and the bottom portion of the fuselage. The exposed blades of the port and starboard propellers may then be in the center of the aircraft, over the central opening and the overlapping portions may be in the slots extending into the fuselage from this central fuselage opening.

An aircraft includes vents for allowing airflow to flow through the fuselage. The vents may form a portion of the outer surface of the fuselage and may overlap with each other to form a partially stacked configuration, wherein a portion of a first vent overlaps with a portion of a second adjacent vent, to form a scale like configuration. The vents may be configured in a top surface of aircraft or upper vents or may be configured along a bottom surface, lower vents. An aircraft may include both upper and lower vents that may be controlled separately to maneuver the aircraft and produce lift, and forward or reverse thrust. The vents may be opened to allow a large amount of airflow through the fuselage for hovering and then the vents may rotate to direct the airflow through the fuselage in an offset angle with respect to the length axis to produce either forward or reverse thrust. The vents may include a planar surface, and may be planar bodies with opposing parallel planar surfaces. The vents may be coupled to the fuselage by a pivot and configured to pivot about said pivot from an open position, to a closed position. The pivot may be configured between the ends of the vent, such as centrally located to reduce the torque require to rotation the vent.

An aircraft may also include rudders that extend from the fuselage and configured to stabilize the aircraft during flight and may act as landing feet as they may extend down from the fuselage such that the rudders make contact with a ground surface first upon landing. An aircraft may include a pair of forward or front rudders and/or a pair of stern rudders, configured more proximal to the back or stern of the aircraft. The rudders may extend out at an angle with respect to the fuselage plane and this angle may be reduced during flight to bring the length axis of the rudders up into closer alignment with the plane of the fuselage, whereby the rudders act as wings to provide lift for flight of the aircraft.

An exemplary aircraft may be a drone and comprise a flight controller with a computer such as a microprocessor for receiving input and controlling the functions of the aircraft, such as rudder position, speed of the propellers including the port, starboard and stern propellers, position of the vents, including the upper and lower vents, lights, camera orientation, package release and the like. A wireless signal transceiver may include a signal receiver that receives a wireless signal from a remote source. An operator may be standing on the ground and controlling the flight of the aircraft from a remote controller.

In an exemplary embodiment, an aircraft, such as a hoverbike, may include forward vents, or vents configured along a top of the aircraft and forward the pilot. A hoverbike may also include upper vents configured under and aft the pilot. A hoverbike may include lower vents along a bottom of the fuselage. Also, an aircraft may include yaw vents that are configured to rotate to steer the aircraft.

A hoverbike may include a thrust pedal that is operable by the pilot to change the amount of forward thrust or reverse thrust. The thrust pedal may be configured for operation by a pilot's foot, like a gas pedal in an automobile. The thrust pedal may be mechanically linked with the vents including, the forward, upper and/or lower vents to change a rotational position of the vents for changing thrust. The thrust pedal may be coupled with a flight controller and the flight controller may then adjust the angles of the vents and may also change a rotational speed of one or more of the propellers.

A hoverbike may include a steering handle that is configured for a pilot to turn with their hand or hands to turn the aircraft. The steering handle may be mechanically coupled with the yaw vents, wherein turning the steering handle mechanically turns or rotates the yaw vents. However, the steering handle may be coupled with a flight controller and the flight controller may then adjust the angles of the yaw vents and may also change a rotational speed of one or more of the propellers to control the turning of the aircraft.

A hoverbike may include a pitch handle pivot, a user input coupled to the steering handle for controlling the pitch of the aircraft. The pitch handle pivot may enable the steering handle to rotate forward about the pitch handle pivot to cause a downward pitch and rotate back about the pitch handle pivot to cause an upward pitch of the aircraft. The pitch handle pivot may be coupled with a flight controller and the flight controller may then adjust the angles of vents and may also change a rotational speed of one or more of the propellers to control the aircraft. The speed of the stern propeller may be increased to cause a downward pitch, for example.

A hoverbike may have wheels configured from or extending from the bottom of the fuselage to enable the aircraft to roll on a ground surface, such as during take-off, landing or when maneuvering the aircraft for transport on the ground.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a perspective view of an exemplary aircraft in hover mode with the front and back port propellers and front and back starboard propellers rotating to produce airflow through the fuselage opening created by the vents being in an open position.

FIG. 2 shows a side view of the aircraft shown in FIG. 1.

FIG. 3 shows a top view of the aircraft shown in FIG. 1.

FIG. 4 shows a front view of the aircraft shown in FIG. 1.

FIG. 5 shows a perspective view of the exemplary aircraft shown in FIG. 1, now in forward flight mode, with the stern propeller now rotating to produce thrust to propel the aircraft forward and with the vents configured between an open and closed position, or partially closed to reduce drag for forward propulsion.

FIG. 6 shows a side view of the aircraft shown in FIG. 5.

FIG. 7 shows a top view of the aircraft shown in FIG. 5.

FIG. 8 shows a front view of the aircraft shown in FIG. 5.

FIG. 9 shows a perspective view of the exemplary aircraft shown in FIG. 1, now in fast forward flight mode, with the stern propeller rotating to produce thrust to propel the aircraft forward and with the vents configured in a fully closed position wherein the vents form a portion of an outer surface of the fuselage.

FIG. 10 shows a side view of the aircraft shown in FIG. 9.

FIG. 11 shows a top view of the aircraft shown in FIG. 9.

FIG. 12 shows a front view of the aircraft shown in FIG. 9.

FIG. 13 shows a perspective view an exemplary aircraft in three modes, hovering, forward flight and fast forward flight.

FIG. 14 shows a perspective view of an aircraft having two port and two starboard propellers that have a portion of the propeller blade that overlaps the fuselage and a stern propeller to provide thrust.

FIG. 15 shows a side view of the aircraft shown in FIG. 14.

FIG. 16 shows a top view of the aircraft shown in FIG. 14.

FIG. 17 shows a front view of the aircraft shown in FIG. 14.

FIG. 18 shows a perspective view of the port side of a hoverbike having propellers that have a portion that overlaps the fuselage and vents configured to direct and guide airflow through the fuselage for hovering, forward thrust and reverse thrust.

FIG. 19 shows a perspective view of the starboard side of the hoverbike shown in FIG. 18.

FIG. 20 shows a front view of the hoverbike shown in FIG. 18 in a hovering mode.

FIG. 21 shows a top view of the hoverbike shown in FIG. 18 in a hovering mode.

FIG. 22 shows a side view of the hoverbike shown in FIG. 18 in a hovering mode.

FIG. 23 shows a bottom view of the hoverbike shown in FIG. 18 in a hovering mode.

FIG. 24 shows a front view of the hoverbike shown in FIG. 18 in a forward flight mode.

FIG. 25 shows a top view of the hoverbike shown in FIG. 18 in a forward flight mode.

FIG. 26 shows a side view of the hoverbike shown in FIG. 18 in a forward flight mode.

FIG. 27 shows a bottom view of the hoverbike shown in FIG. 18 in a forward flight mode.

FIG. 28 shows a front view of the hoverbike shown in FIG. 18 in a reverse thrust mode.

FIG. 29 shows a top view of the hoverbike shown in FIG. 18 in a reverse thrust mode.

FIG. 30 shows a side view of the hoverbike shown in FIG. 18 in a reverse thrust mode.

FIG. 31 shows a bottom view of the hoverbike shown in FIG. 18 in a reverse thrust mode.

FIG. 32 shows a side view of a portion of the hoverbike shown in FIGS. 18 to 30 with a thrust pedal to control airflow through the fuselage and a steering handle that is coupled with the yaw vents to steer the hoverbike.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

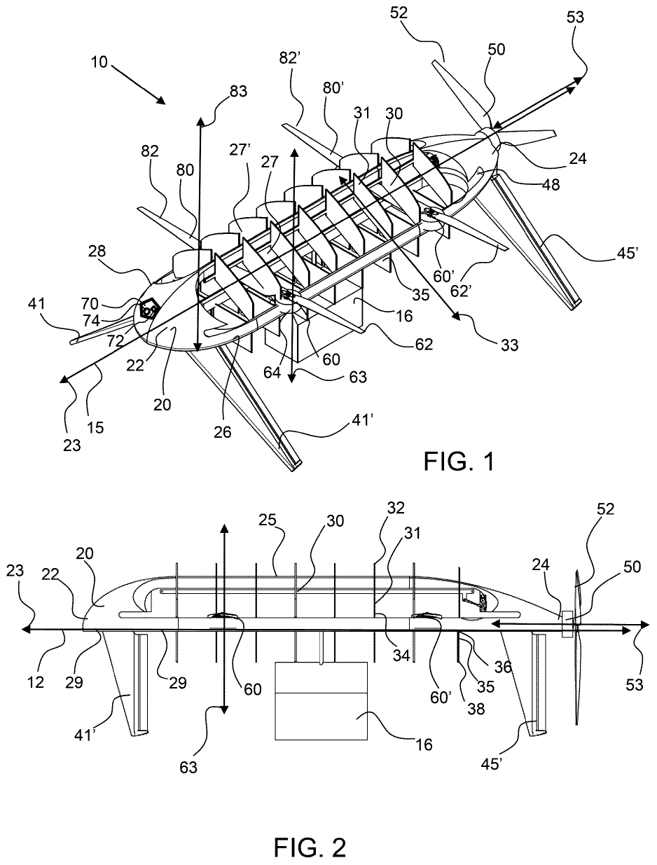

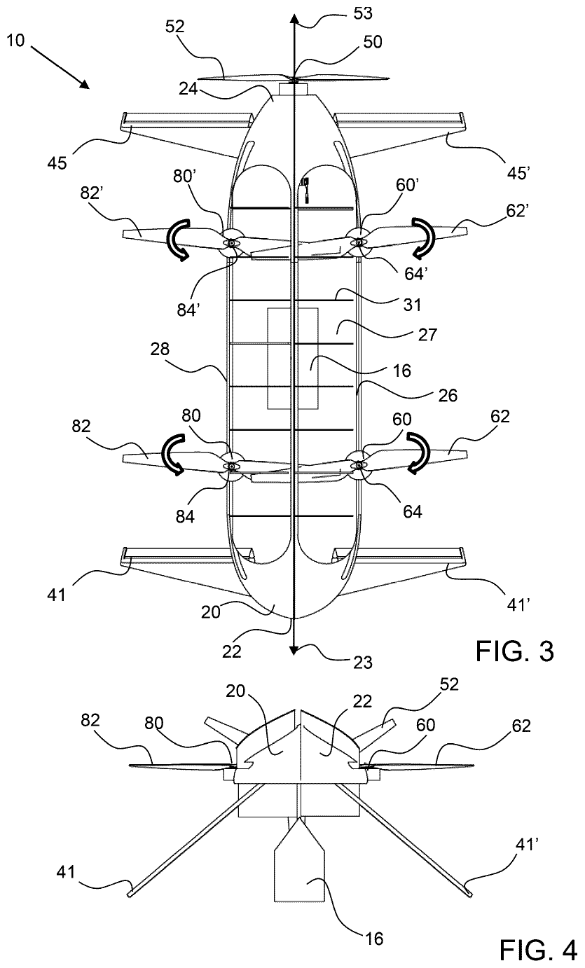

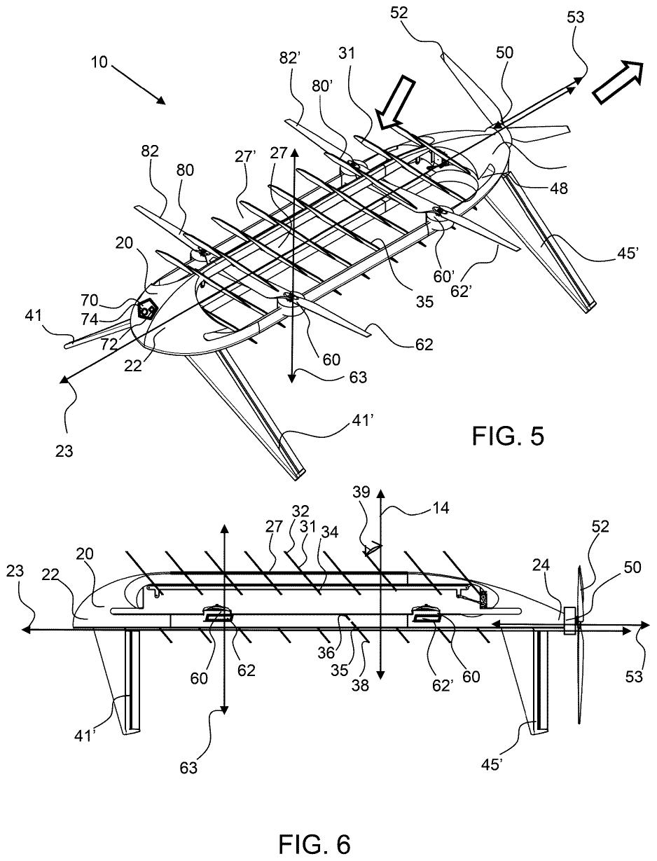

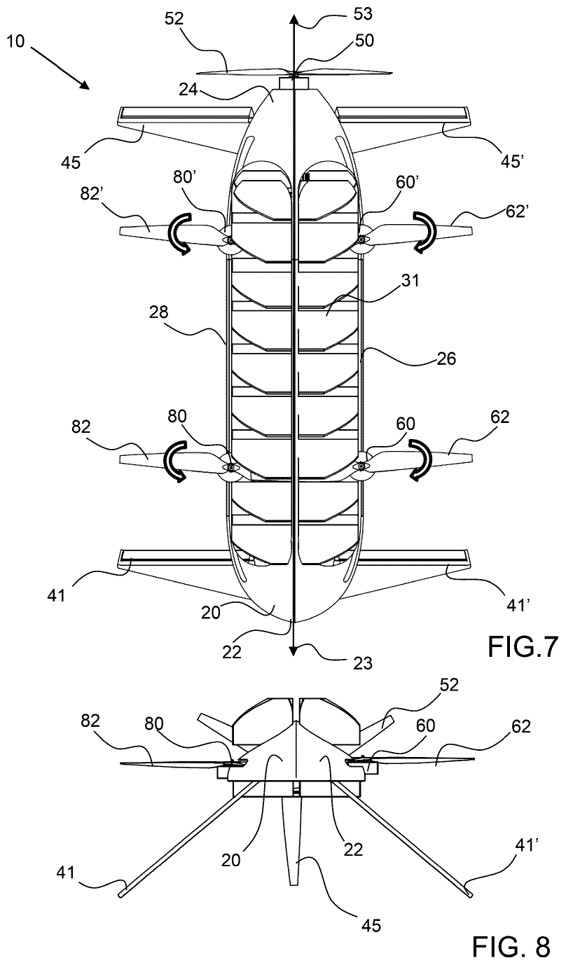

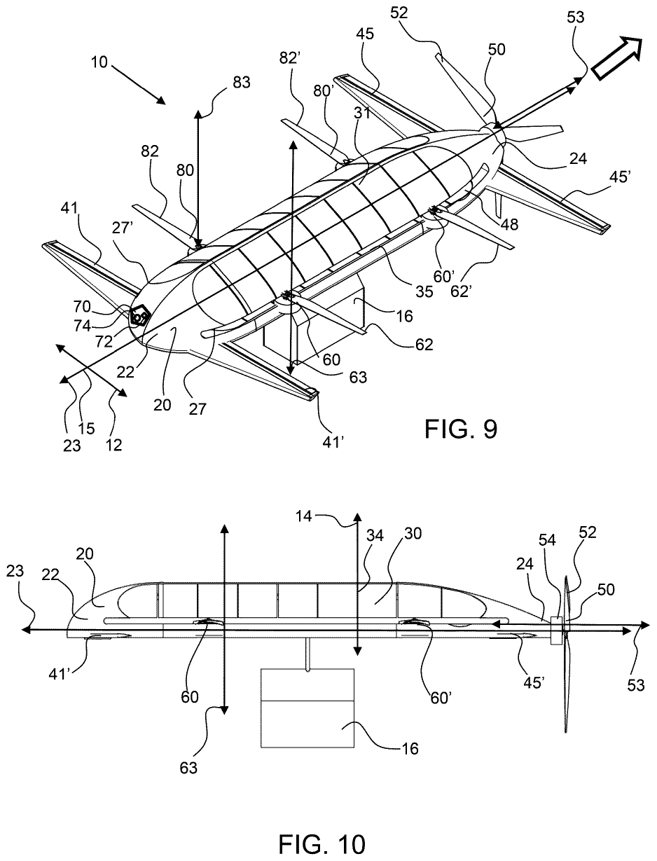

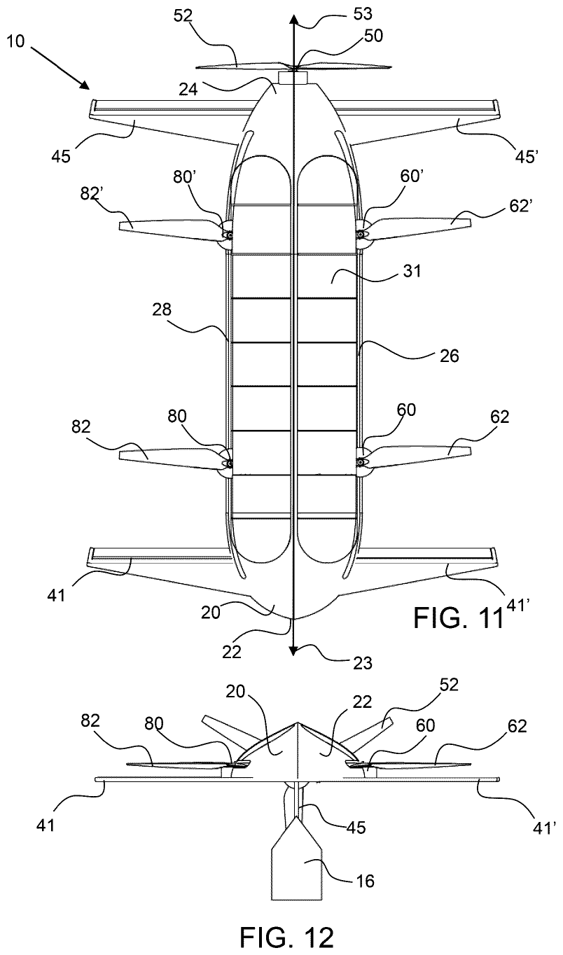

Referring now to FIGS. 1 to 13, an exemplary aircraft 10 includes a pair of port propellers 60, 60′ that extend from the port side 26 of the fuselage 20, and a pair of starboard propellers 80, 80′ that extend from the starboard side 28 of the fuselage 20. The port and starboard propellers partially overlap with the fuselage 20, when viewed from a top-down orientation as seen in FIG. 3. In this aircraft 10, a portion of the propellers are configured within the fuselage, between the top 25 and bottom 29 of the fuselage 20. The plurality of vents 30 are configured to transition from an open position to allow airflow through the fuselage for hovering to a partially closed position for forward flight to a closed position during fast forward flight. The aircraft also has a stern propeller 50 that provides thrust to propel the aircraft forward. The aircraft is configured to transition from a hover mode, as shown in FIG. 1 to 4 to a forward flight mode as shown in FIG. 5 to 8 and finally to a fast forward flight mode as shown in FIGS. 9 to 12.

The aircraft has a front port propeller 60 and a back port propeller 60′. The front port propeller 60 has port propeller blades 62 coupled to a port hub 64 that rotate about a port propeller rotation axis 63 and likewise the back port propeller has port propeller blades 62′ that rotate about a port propeller rotation axis. The aircraft also has a front starboard propeller 80 and a back starboard propeller 80′. The front starboard propeller 80 has starboard propeller blades 82 coupled to a starboard hub 84 that rotate about a starboard propeller rotation axis 83 and likewise the back starboard propeller 80′ has starboard propeller blades 82′ that rotate about a starboard propeller rotation axis. The rotational axes of the port propellers may be parallel and the rotational axes of the starboard propellers may also be parallel.

The propeller blades extend into a fuselage slot 48 configured between the top 25 and bottom 29 of the fuselage and extending in from the port side 26 and starboard sides 28. The upper vents 31 and lower vents 35 form an outer surface of the fuselage when in a closed position, as shown in FIGS. 9 to 12.

The aircraft has a plurality of upper vents 31 and lower vents 35. The upper vents include upper port vents configured on the port side of the fuselage and upper starboard vents configured on the starboard side of the fuselage. Port side being between the centerline 15 of the aircraft from front to back and the port side 26. Starboard side being between the centerline 15 of the aircraft and the starboard side 28. Likewise, the lower vents 35 include lower port vents configured on the port side and lower starboard vents configured on the starboard side of the fuselage. The upper vents 31 are configured more proximal to the top 25 of the fuselage 20 than the lower vents 35. In addition, the vents may form a portion of the outer surface of the fuselage, as shown in FIGS. 9 and 10, wherein the upper vents 31 and lower vents 35 are in a fully close position and from a portion of the outer surface of the fuselage 20. The vents may rotate and may overlap each other forming scales along the fuselage surface. This closed configuration will prevent airflow through the fuselage caused by the rotation of the port and starboard propellers.

The aircraft has flow channels, 27, 27′ to allow airflow into and through the fuselage that can be directed for lift or otherwise maneuvering the aircraft. As shown in FIG. 1, a port side flow channel 27 is configured on the port side 26 of the fuselage and between the port side upper vents. Also shown in FIG. 1 is a starboard side flow channel 27′ configured on the starboard side 28 of the fuselage 20 between the starboard side upper vents 31. This same arrangement may be configured on the bottom between the lower vents 35 to allow the airflow to flow through the upper vents 31, the fuselage 20 and then out through the lower vents 35, with the upper vents and lower vents in an open configuration.

The aircraft also has a stern propeller 50 configured at the back 24 of the fuselage 20 and configured to rotate about a stern propeller hub 54 and about a stern propeller rotational axis 53. The stern propeller 50 has a plurality of stern propeller blades 52 that when rotating produce thrust to propel the aircraft 10 forward.

The aircraft has a pair of front rudders including a port front rudder 41′ and starboard front rudder 41 and a pair of stern rudders including a port stern rudder 45′ and starboard stern rudder 45. As shown in FIG. 1, the rudders are angled down from the fuselage and as shown in FIG. 9, the rudders are rotated up toward the fuselage such that they act as wings to provide lift for the aircraft as it is in forward flight. The rudders shown in FIG. 9 are substantially aligned or parallel with the plane of the fuselage 12 (indicated by the two orthogonal lines, one along the centerline 15 length axis 23 and the other orthogonal and from the port to the starboard side of the fuselage), or a plane extending centrally through the fuselage from the front to the back and from the port side to the starboard side.

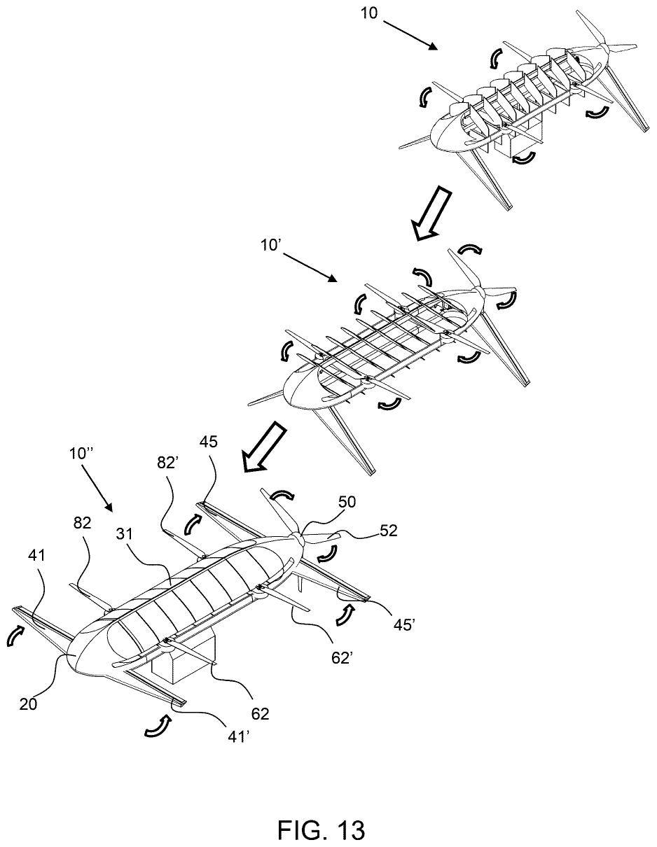

The aircraft is configured to take off and hover in a hover mode as shown in FIGS. 1 to 4 and then progress to forward flight as shown in FIGS. 5 to 8 and finally to fast forward flight as shown in FIGS. 9 to 12. A summary showing the transition in the orientation of the features and operation is shown in FIG. 13.

As shown in FIGS. 1 to 4, the front port propeller 60, back port propeller 60′, front starboard propeller 80 and back starboard propeller 80′ are spinning to produce airflow through the open vents 30 and through the fuselage 20 to produce lift. The propeller blades are spinning in direction as indicated by the bold arrow over the extended propeller blades, extended out from the fuselage. Note that the advancing portion of the propeller blade is extended and exposed and the retreating propeller blade, spinning back from the direction of motion, overlaps with the fuselage and may be protected from airflow. Having the retreating portion of the propeller, or retreating propeller blade hidden or protected from airflow from forward flight may increase the efficiency of the propeller for producing lift. Since the aircraft is not moving forward or moving forward slowly, the lift is produced by the spinning port and starboard propellers. As best shown in FIG. 3, the port propeller hubs 64, 64′ and the starboard hubs 84, 84′ partially overlap with the fuselage or are configured at least partially within the fuselage perimeter when viewed from above. Also, a portion of the port and starboard propellers overlap with the fuselage, such as about 50% of the propeller. As shown, an entire propeller blade of each of the port and each of the starboard propellers overlaps with the fuselage. The stern propeller 50 may also be spinning to produce slow forward motion, or forward motion below a threshold velocity. The fuselage 20 has fuselage openings 21 and flow channels 27 formed by the open vents to allow airflow from the top through to the bottom of the fuselage. The vents 30 include upper vents 31 and lower vents 35. The upper vents are open or rotated about the upper vent rotational axis 33 to extend substantially perpendicular to the fuselage plane 12. The leading end 32 of the upper vents 31 are vertically aligned with the trailing end 34 to direct the airflow down through the aircraft fuselage along the planar surface of the vents. The vents may have planar surfaces along the front and back of the plate. Likewise, the leading end 36 of the lower vents 35 are vertically aligned with the trailing end 38 to direct the airflow down through the aircraft fuselage along the planar surface of the vents. The vents may have planar surfaces along the front and back of the plate. The vents may include a planar portion and the plane of this planar portion may be substantially perpendicular (within about 20 degrees) of the fuselage plane 12 in this hovering configuration, as best shown in FIG. 2. The front rudders 41, 41′ and stern rudders 45, 45′ are configured in a down position to provide some stability in the hovering mode.

As shown in FIGS. 5 to 8, the aircraft has transitioned to forward flight mode with the vents 30 partially closed or rotated with a leading end (edge) toward the front of the fuselage 20. The vents are rotated to an offset angle 39 to the vertical axis 14 as shown in FIG. 4. The leading end 32 of the upper vent 31 is more proximal to the front 22 of the fuselage 20 than the trailing end 34 to direct the airflow from the front to the back of the aircraft along the vents. The vents may have planar surfaces along the front and back of the plate. Likewise, the leading end 36 of the lower vent 35 is more proximal to the front 22 of the fuselage 20 than the trailing end 38 to direct the airflow from the front to the back of the aircraft along the planar surface of the vents. The vents may have planar surfaces along the front and back of the plate. In this mode, the port propellers 60, 60′ and starboard propeller 80, 80′ may continue to spin and the stern propeller 50 may spin more quickly to increase the forward velocity form the hover mode.

As shown in FIGS. 9 to 12, the aircraft 10 is now in a fast forward flight mode with the vents fully closed to form a portion of an outer surface of the fuselage 20 and with the port propellers 60, 60′ and starboard propeller 80, 80′ fixed and not rotating. The vents may be rotated to an offset angle of about 90 degrees from the vertical axis 14, or within about 10 degrees of a 90 degree offset angle. Also, the front rudders 41, 41′ and back rudders 45, 45′ are rotated up to act as wings.

As shown throughout FIGS. 1 to 12, the drone may be configured to transport a package 16 and may be adapted to release the package at a delivery location. Also, the drone may be configured with a camera, a weapon, or other known equipment known to be carried and interfaced with during drone flight.

As shown throughout FIGS. 1, 5 and 9, the drone includes a controller 70, such as a flight controller, having a computer or microprocessor 72 to run a computer program that receives inputs and then controls functions of the aircraft. Also, a wireless signal transceiver 74 include a wireless signal receiver that is configured to receive a wireless signal from a remote controller. These wireless signals may include flight instructions or desired changes in the flight, such as to increase or decrease speed, change direction, ascend, descend, and the like.

FIG. 13 shows the aircraft as shown in FIGS. 1 to 12 transitioning from a hover mode, to a forward flight mode to a fast forward flight mode. The aircraft 10 is in a hover mode with the upper vents 31 and lower vents 34 both open to allow airflow through the fuselage 20 and the stern propeller 50 is not spinning. The port propeller 60 and stern propellers 80 are spinning with the exposed propeller blades being the advancing blades and with the retreating blades overlapping with the fuselage. Also, in the hover mode the rudders are configured in a down position. The aircraft 10′ is in a forward flight mode, with the vents now configured partially closed and with the stern propeller 50 now turning to provide forward thrust. The rudders are in a down position. The aircraft 10″ is in a fast forward flight mode with the upper vents 31 and lower vents closed and with the port propellers 60, 60′ and starboard propellers 80, 80′ now fixed such that their respective propeller blades act as wings. The front rudders 41, 41′ and back rudders 45, 45′ are now rotated upward to be more in plane with the plane of the fuselage 12. The bold arrows in FIG. 13 show the direction of rotation of propellers, rudders and vents. As described herein, the upper vents and the lower vents may be closed and for a portion of the shell or enclosure of the fuselage.

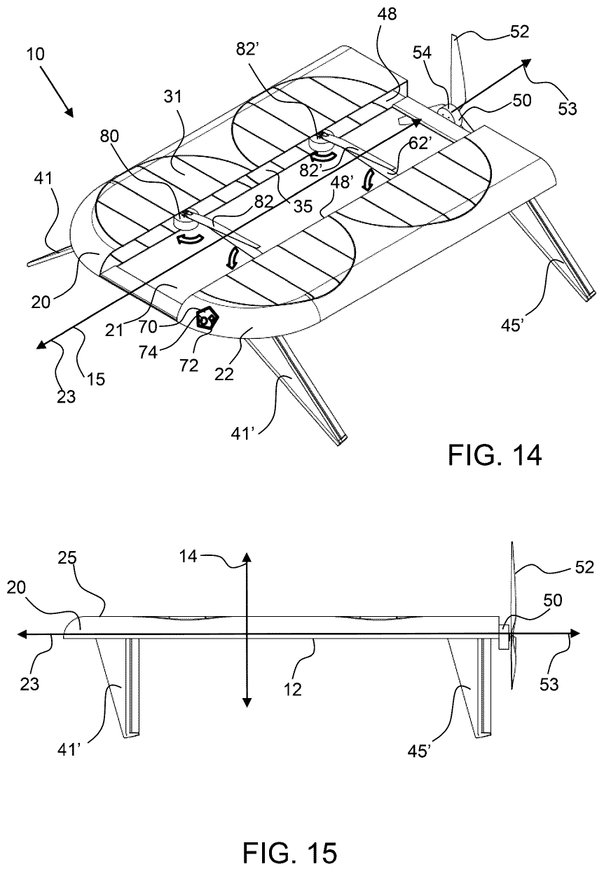

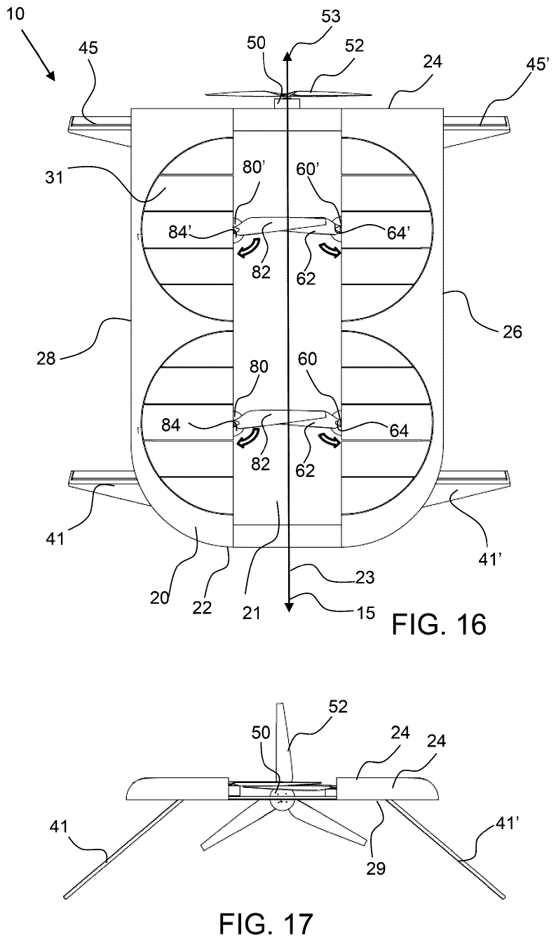

Referring now to FIGS. 14 to 17, an aircraft 10 has two port propellers 60, 60′ and two starboard propellers 80, 80′ that have a portion of their respective propeller blade that overlaps the fuselage 20 and a stern propeller 50 to provide thrust. The two port propellers 60, 60′ are configured on a port side 26, wherein the port propeller hub 64 is configured between the centerline 15 and the port side. Likewise, the two starboard propeller 80, 80′ are configured on a starboard side 28, wherein the starboard propeller hub 84 is configured between the centerline and the starboard side. The port and stern propellers have a portion of the propeller blade that overlaps with the fuselage 20 for isolating the relative wind and extend into a respective fuselage slot 48, 48′. The retreating blades are configured within said slot in the fuselage and a center fuselage opening 21 is configured for the exposed portion of the blades to produce upward lift. The direction of the port and starboard propeller rotation is indicated by the bold arrows. This aircraft has two port propellers 60, 60′ and two starboard propellers 80, 80′. The port propellers and starboard propellers overlap each other in the center fuselage opening. The fuselage has a top portion extending on the top 25 of the fuselage and a bottom portion extending along the bottom 29 of the fuselage. The upper vents 31 and the lower vents 35 are planar with the top 25 of the fuselage 20 as shown in FIG. 14 and the upper vents and lower vents create a slot for the port and starboard propeller blades to rotate between. As described herein, the upper vents and the lower vents may be closed and form a portion of the shell or enclosure of the fuselage.

The aircraft 10 has a stern propeller 50 with propeller blades 52 that spin about the stern hub 54 and about the stern rotational axis 53 to provide forward thrust for the aircraft. The rotational axis 53 of the stern propeller is aligned with the length axis 23 of the fuselage from the front 22 to the back 24 of the fuselage and centrally oriented between the port side 26 and the starboard side 28.

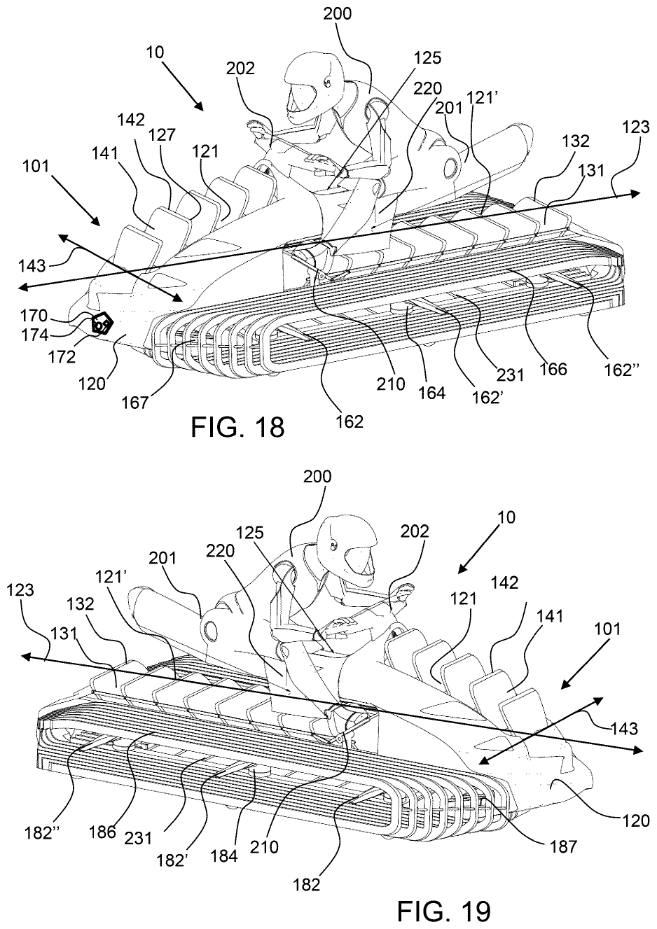

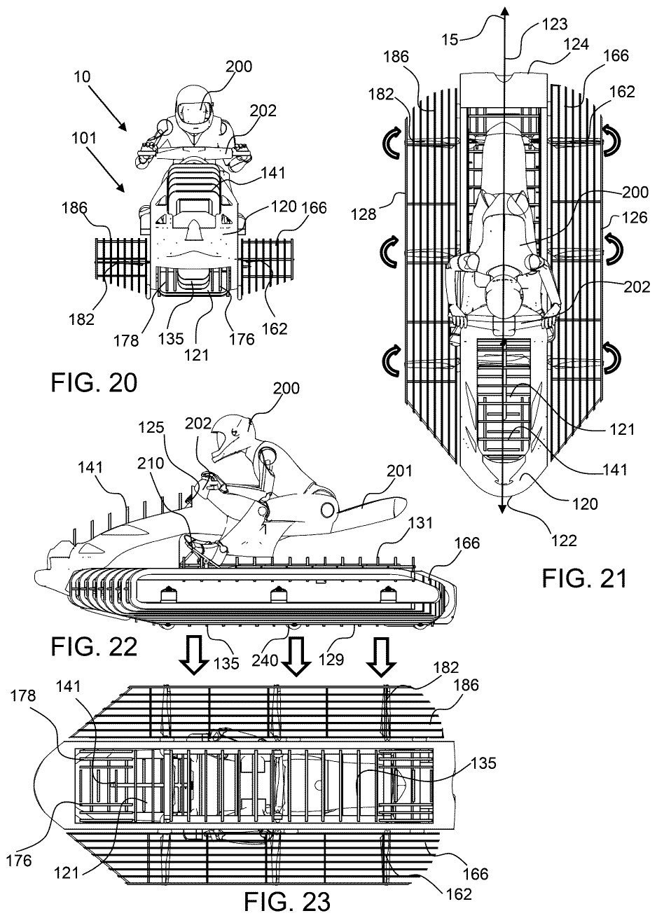

Referring now to FIGS. 18 to 31, an exemplary aircraft 10 is a hoverbike 101 configured to transport a pilot 200 in flight and comprises a seat 201 for the pilot. The fuselage has a length axis 123 extending along a centerline 15 from the front 122 to the back 124 of the fuselage and a vertical axis 14 extending from the bottom 129 to the top 125 of the fuselage. The hoverbike 101 has a plurality of port propellers 160 and starboard propellers 180 that provide lift and both forward and reverse thrust with proper orientation of the vents. The hoverbike is turned by the port yaw vents 176 and starboard yaw vents 178 that are configured in the front fuselage opening 121, as shown in FIG. 20. The hoverbike has forward vents 141, upper vents 131 and lower vents 135 that are all configured for adjustment in rotational position to maneuver the hoverbike 101. The vents, including the forward vents 141, upper vents 131 and lower vents 135 may included planar surfaces and may be considered plates having a front and back planar surface that is parallel, or within about 20 degrees of parallel. The vents form flow channels 127 through the fuselage.

A port propeller shield 166 with port propeller openings 167 is configured over the exposed portion of the port propeller blades 162, 162′, 162″ and a starboard propeller shield 186 with starboard propeller shield openings 187 is configured over the exposed portion of the starboard propeller blades 182, 182′, 182″. These propeller shields are configured to prevent the pilot from contacting the turning propeller blades and are for protection. The shields include openings shield openings to enable airflow down through the shields and also openings from the front to the back to allow airflow over the propeller blades during flight.

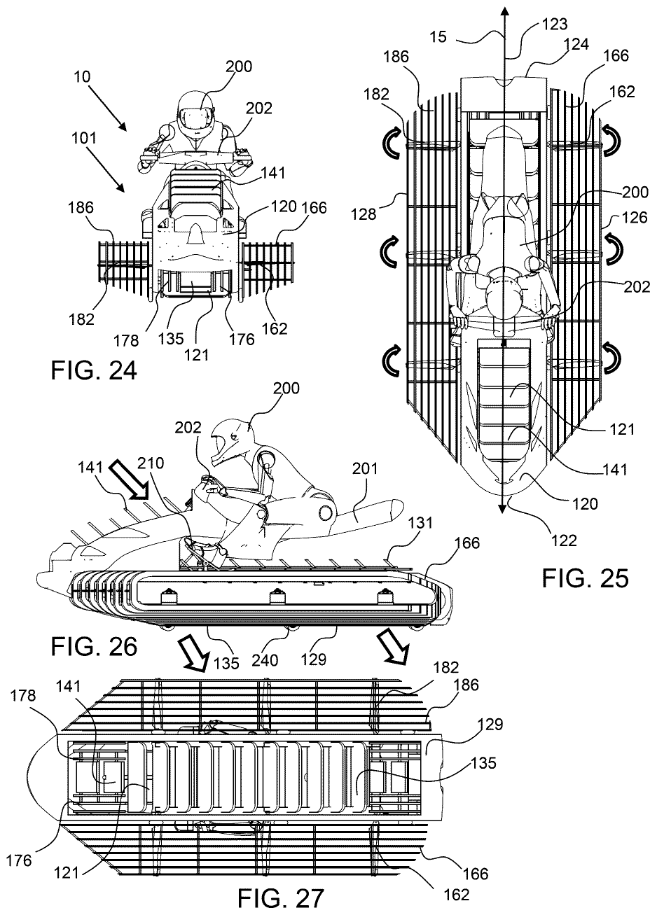

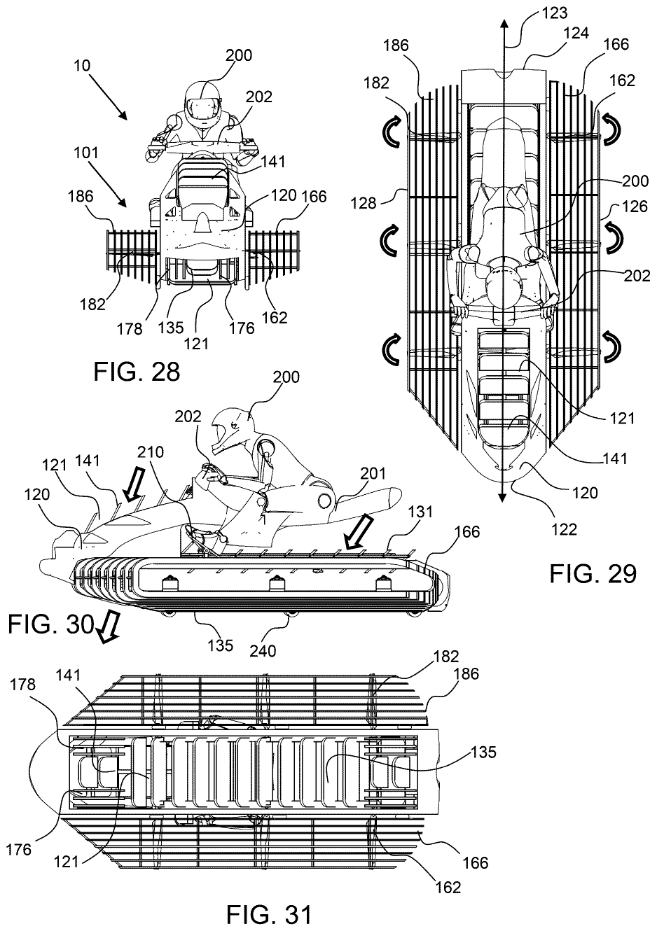

The hoverbike 101 has forward vents 141 configured for receiving airflow down through the fuselage 120 and out the bottom 129 of the hoverbike. The forward vents are configured forward the pilot 200 and proximal the front 122 of the fuselage 120. There are five forward vents shown. These forward vents are configured to open and close to allow more or less airflow through the fuselage and the forward vents may be rotated such that airflow is directed for hovering, forward thrust or reverse thrust. The forward vents may be planar panels configured to rotate, wherein they may be vertical for hovering or lift as shown in FIG. 20 to 23, and rotated with the leading end 142 forward the trailing edge of the forward vent to produce airflow from the front 122 towards the back 124 of the fuselage, to enable forward thrust, as shown in FIGS. 24 to 27. The forward vents may be rotated to orient the leading end 142 back from the trailing edge to direct airflow in a reverse direction, or from a back position to a front position of the fuselage, as shown in FIGS. 28 to 31.

The hoverbike 101 has upper vents 131 configured for receiving airflow down through the fuselage 120 and out the bottom 129 of the hoverbike. The upper vents are configured along the top 125 of the fuselage and are configured under and back from the pilot. There are eight upper vents shown. These upper vents are configured to open and close to allow more or less airflow through the fuselage. The upper vents may be rotated such that airflow is directed for hovering, forward thrust or reverse thrust. The upper vents may be planar panels configured to rotate, wherein they may be vertical for hovering or lift as shown in FIG. 20 to 23, and rotated with the leading end 132 forward the trailing edge of the upper vent to produce airflow from the front 122 towards the back 124 of the fuselage, to enable forward thrust, as shown in FIGS. 24 to 27. The upper vents may be rotated to orient the leading end 132 back from the trailing edge to direct airflow in a reverse direction, or from a back position to a front position of the fuselage, as shown in FIGS. 28 to 31.

The hoverbike 101 has lower vents 135 configured for receiving airflow down through the fuselage 120 and out the bottom 129 of the hoverbike. The lower vents are configured along the bottom 129 of the fuselage and are configured under and back from the pilot. There are eleven lower vents shown. These lower vents are configured to open and close to allow more or less airflow through the fuselage. The lower vents may be rotated such that airflow is directed for hovering, forward thrust or reverse thrust. The lower vents may be planar panels configured to rotate, wherein they may be vertical for hovering or lift as shown in FIG. 20 to 23, and rotated with the leading end forward the trailing end of the lower vent to produce airflow from the front 122 towards the back 124 of the fuselage, to enable forward thrust, as shown in FIGS. 24 to 27. The lower vents may be rotated to orient the leading end back from the trailing edge to direct airflow in a reverse direction, or from a back position to a front position of the fuselage, as shown in FIGS. 28 to 31.

The port propellers blades 162, 162′, 162″ and the starboard propeller blades 182, 182′, 182″ rotate between the upper vents 131 and lower vents 135. A portion of the propeller blades overlaps with the fuselage 120 and the with the upper and lower vents and a portion of the propeller blades are exposed, or extend out from the fuselage. This exposed region of the propeller blade is covered by a shield for safety. As shown in FIGS. 21, 25 and 29, the port propellers blades 162, 162′, 162″ rotate counter clockwise from a top view and therefore the exposed portion of the port propeller blade is receding or spinning from front to back of the fuselage 120. The starboard propellers blades 182, 182′, 182″ rotate clockwise from a top view and therefore the exposed portion of the starboard propeller blade is receding or spinning from front to back of the fuselage 120.

The hoverbike has wheels 240 that are configured to allow the hoverbike to roll along a ground surface for take-off, landing or for transport of the hoverbike along a ground surface.

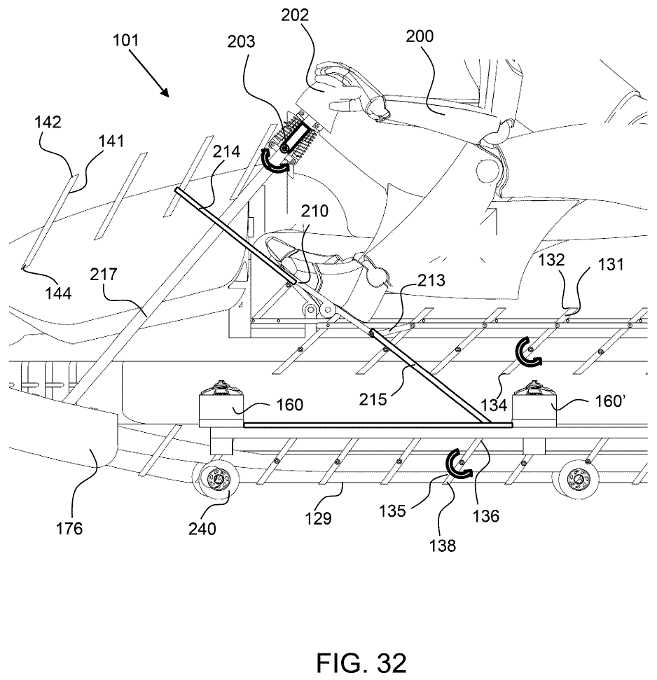

As shown in FIG. 32, the hoverbike 101 has pilot 200 controls including a steering handle 202 coupled to a yaw vent linkage 217, a thrust pedal 210 coupled with a lower vent linkage 215, upper vent linkage 213 and a forward vent linkage 214, and a pitch handle pivot 203. The steering handle rotates the yaw vent linkage 217 to rotate the port yaw vents 176 and the starboard yaw vents 178, not shown in FIG. 32, to steer or turn the hoverbike 101. The thrust pedal 210 is coupled with an upper vent linkage 213, a forward vent linkage 214 and a lower vent linkage 215 to change the orientation of the upper vents 131, forward vents 141 and the lower vents 135, respectively. The pitch handle pivot 203 enables a pilot 200 to tilt the steering handle 202 forward to pitch the hoverbike down, or with the front lower than the back to dive or lower elevation of the hoverbike with respect to the ground, or tilt the steering handle backward about the pitch handle pivot to pitch the hoverbike 101 upward, or with the front of the fuselage higher than the back, to climb in elevation from the ground. These linkages may be mechanical linkages, such as a rod or shaft that is coupled with vents to physical move the vents when the thrust pedal is actuated. However, a linkage from the thrust pedal and/or the steering handle may be indirect, wherein the user input is measured and provided to the drive controller that then sends a signal for the actuation of the vents based on the user input.

As shown, the forward vents 141 are planar panels that extend from the leading end 142 to the trailing end 144, wherein the leading end receives air and said air passes over the forward vent to the trailing end. Likewise, the upper vents 131 are planar panels that extend from the leading end 132 to the trailing end 134, wherein the leading end receives air and said air passes over the forward vent to the trailing end. The lower vents 135 are planar panels that extend from the leading end 136 to the trailing end 138, wherein the leading end receives air and said air passes over the forward vent to the trailing end. Two of the starboard propellers 160, 160′ are shown and are configured between the upper vents and the lower vents. The starboard propeller blades rotate between the upper and lower vents.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. An aircraft comprising:
a) a fuselage having a length axis from a front of said aircraft to a back of said aircraft and a width from a port side to a starboard side;
b) a port propeller having port propeller blades that are configured on said port side of the fuselage, and wherein the port propeller rotates about a port propeller rotational axis;
wherein a portion of the port propeller blades overlap the fuselage and wherein a portion of the port propeller blades are exposed from the fuselage;
c) a starboard propeller having starboard propeller blades that extend from said starboard side of the fuselage; and wherein the starboard propeller rotates about a starboard propeller rotational axis;
wherein a portion of the starboard propeller blades overlap the fuselage;
wherein a portion of the starboard propeller blades are exposed from the fuselage;
d) a plurality of vents configured along the fuselage that are configured to move from a closed position that prevents airflow through the fuselage to an open position that allows airflow through the fuselage produced by the port propeller and the starboard propeller;
wherein the plurality of vents comprises a plurality of upper vents configured along a top of the fuselage;
wherein the plurality of vents further comprises a plurality of lower vents configured along a bottom of the fuselage; and
wherein both the starboard propeller blades and port propeller blades rotate between the plurality of upper vents and plurality of lower vents.

2. The aircraft of claim 1, further comprising a stem propeller configured at the back of the aircraft and having stern propeller blades that rotate about a stern axis that is substantially parallel with the length axis of the fuselage.

3. The aircraft of claim 1, wherein the port propeller and the starboard propeller are configured to stop rotating during forward flight above a threshold velocity and wherein one of the port propeller blade and one of the starboard propeller blade is configured to extend out from the port side and starboard side respectively to act as a wing.

4. The aircraft of claim 1, wherein the port propeller has a port hub and wherein at least a portion of the port hub overlaps with the fuselage.

5. The aircraft of claim 4, wherein the starboard propeller has a starboard hub and wherein at least a portion of the starboard hub overlaps with the fuselage.

6. The aircraft of claim 1, comprising two port propellers wherein a first port propeller is configured more proximal to the front of the fuselage than a second port propeller, and
comprising two starboard propellers wherein a first starboard propeller is configured more proximal to the front of the fuselage than a second starboard propeller.

7. The aircraft of claim 6, wherein said first port propeller rotational axis is substantially parallel with said second port propeller rotational axis; and
wherein said first starboard propeller rotational axis is substantially parallel with said second starboard propeller rotational axis.

8. The aircraft of claim 1, wherein the port propeller blade extends from the port side of the fuselage.

9. The aircraft of claim 8, wherein the starboard propeller blade extends from the starboard side of the fuselage.

10. The aircraft of claim 9, further comprising a stem propeller configured at the back of the aircraft and having stern propeller blades that rotate about a stern axis that is substantially parallel with the length axis of the fuselage.

11. The aircraft of claim 1, wherein the fuselage has a central open area extending between the port side and the starboard side and wherein the port propeller blade and the starboard propeller blade overlap with the open area for creating lift and overlap with the fuselage on the port side and the starboard side respectively.

12. The aircraft of claim 11, wherein the fuselage has a fuselage opening between the port side and the starboard side and wherein a portion of the port propeller blades and a portion of the starboard propeller blades overlap the fuselage opening.

13. (canceled)

14. (canceled)

15. The aircraft of claim 1, wherein the plurality of upper vents form a top surface of the fuselage when in the closed position.

16. The aircraft of claim 15, wherein the plurality of upper vents overlap each other when in the closed position.

17. (canceled)

18. The aircraft of claim 1, wherein the plurality of lower vents form a bottom surface of the fuselage when in the closed position.

19. The aircraft of claim 18, wherein the plurality of lower vents overlap each other when in the closed position.

20. (canceled)

21. The aircraft of claim 1, wherein the plurality of lower vents form a bottom surface of the fuselage when in the closed position.

22. The aircraft of claim 1, wherein the plurality of vents comprises a plurality of port vents configured along the port side of the fuselage and a plurality of starboard vents configured along the starboard side of the fuselage.

23. The aircraft of claim 1, wherein the plurality of vents comprises a plurality of upper port vents configured along the port side and a plurality of lower port vents configured along the port side and configured more proximal to a bottom of the fuselage than the upper port vents; and
wherein the plurality of vents comprises a plurality of upper starboard vents configured along the starboard side and a plurality of lower starboard vents configured along the starboard side and configured more proximal to a bottom of the fuselage than the upper port vents.

24. The aircraft of claim 23, wherein the upper port vents form a portion of an upper surface of the fuselage when in the closed position and wherein the upper starboard vents form a portion of said upper surface of the fuselage when in the closed position.

25. The aircraft of claim 24, wherein the lower port vents form a portion of a lower surface of the fuselage when in the closed position and wherein the lower starboard vents form a portion of said lower surface of the fuselage when in the closed position.

26-35. (canceled)

36. The aircraft of claim 1, wherein the aircraft is a hoverbike and further comprises a seat for a pilot.

37-72. (canceled)
